(19) United States
(12) Patent Application Publication
(10) Pub. No.: US 2007/0113444 A1
(43) Pub. Date: May 24, 2007

(54) Motorcycle Jacket License Display

(76) Inventor: James B. Proctor, Brandywine, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 11/164,436

(22) Filed: Nov. 22, 2005

(51) Int. Cl. G09F 21/02

(52) U.S. Cl. 40/586

(57) ABSTRACT

A transparent vinyl pouch is mounted on the lower back of a motorcycle jacket to allow the driver to further customize his/her motorcycle. The pouch carries the license plate in order to keep the customized motorcycle tag-free, or is interchangeable with other customized plates, which complement the driver's helmet and/or motorcycle. The pouch also serves to provide greater visibility to the license plate. The pouch is worn on the lower back so other drivers can easily see it. In alternative embodiments of the present invention, there may be hooks inside the pouch, which serve as additional support of the license plate, and there may be lights centered about the license plate, or reflective paint used in order to increase visibility of the plate at nighttime or in bad weather conditions. The pouch closure may also have a locking device to prevent the closure (zipper or hook-and-loop closure) from opening and therefore preventing loss or theft of the license plate.

### FIELD OF THE INVENTION

The present invention relates to a motorcycle jacket that has a vinyl pouch on the back which houses the motorcycle license plate in order to keep the custom motorcycle tag-free.

### BACKGROUND OF THE INVENTION

Motorcycle enthusiasts may spend much time and money decorating and customizing their motorcycles. They may add elaborate detailing, logos and/or designs with various colors.

Some enthusiasts who customize their vehicles may not like the fact that the license plate is mounted onto the back of the motorcycle. For one thing, the plate may detract from the overall look that the user is trying to achieve; when a motorcyclist has spent hours adding detailing and color to his vehicle, he/she may dislike that the license plate clashes with the design or draws attention away from the customized elements. However, the license plate must still be plainly visible. There is a need to place the license plate in a visible location where it will not detract from the rest of the motorcycle. Placing the license plate on clothing is a possible solution to this problem.

Relevant art to the present invention has disclosed patents that allow for illuminated clothing or displays worn on the person to a) indicate turn signals and/or other signaling systems; b) be used for entertainment/advertising purposes. There is also relevant art that is intended for use as safety apparel specifically for a motorcyclist.

U.S. Pat. No. 4,602,191, issued to Davila on Jul. 22, 1986, discloses a jacket with programmable lights for entertainment or advertising purposes. U.S. Pat. No. 4,709,307, issued to Branom on Nov. 24, 1987, is clothing with illuminated display. U.S. Pat. No. 4,825,469, issued to Kincheloe on May 2, 1989, is wearable motorcycle safety apparel, which inflates as an airbag would, when a user suffers an accident. U.S. Pat. No. 5,613,756, issued to Allen on Mar. 25, 1997, is clothing with a pouch for an illuminating device. This pouch is intended for use on various clothing (pant leg or shirt, for example) and is not large enough to accommodate a license plate. U.S. Pat. No. 5,690,411, issued to Vernon Jackman on Nov. 25, 1997, describes a wearable vehicular signaling system for pedestrians, runners, highway workers, etc. that allows oncoming traffic to anticipate in which direction the user will be going. U.S. Pat. No. 6,538,567, issued to Robin Stewart on Mar. 25, 2003, is a motorcycle jacket with illuminated turn signals that correspond with the taillights of the user's motorcycle.

These previous patents are designed to facilitate the clarity of the user's intentions of forward motion, stopping, or moving laterally to the rest of traffic, or intended for use as entertainment or advertisement devices, or used as safety apparel. However, they do not accommodate the aesthetic purposes of a motorcyclist who desires to keep his motorcycle tag-free and the practical purposes of displaying the license plate clearly.

Indeed, there is a need to provide a space for the displaying of the license plate that will not detract from the overall style of the motorcycle and its customized elements, but the license plate must still be in plain view of traffic. The license plate must also be raised above the back wheel of the motorcycle in order to provide better visibility. For example, in rainy conditions the proximity of the license plate to the back tire may obstruct a clear view of the license plate. Placing the plate above the wheel, directly on the jacket, puts the license plate in a more visible position to other drivers.

### SUMMARY OF THE INVENTION

The present invention would provide a way for motorcycle enthusiasts who have heavily-customized motorcycles to keep their vehicles in a pristine, tag-free condition while still displaying the license plate in plain view of other drivers.

The present invention consists in placing a transparent vinyl pouch on the back of the motorcycle jacket. The vinyl pouch is sewn, buttoned or fastened onto the back of the jacket and therefore is made available from the original jacket manufacturers. The vinyl pouch accommodates the license plate of the motorcycle and is secured by a zipper or by a hook-and-loop closure. The plates may also be interchangeable; if the user so desires he/she can install a design plate (which is sold separately) that accentuates and complements the color/design of the helmet or the motorcycle. In this fashion, the user can further customize the vehicle to their taste.

While the present invention is aesthetically useful, it also serves a practical purpose wherein the positioning of the motorcycle's license plate on the back of the jacket provides better visibility. In generally bad weather conditions, the back wheel of the motorcycle may splatter rainwater, mud, or debris onto the license plate, causing it to become dirty and obstructing the plate number. Therefore, positioning the license plate at a higher level on the back of the jacket increases visibility.

An alternative embodiment to the present invention is a pouch with hooks attached to the jacket, under the vinyl pouch. The license plate can be hooked and zippered into the pouch, thereby guaranteeing a more secure fit. Another unique feature of the license plate is that should the rider have an accident, the plate will serve as an added protective device. The tag provides some level of protection to the rider's back should the rider fall off of the motorcycle. The hooks would secure the plate inside the pouch and therefore augment the protective capability of the jacket.

An additional alternative embodiment to the present invention is the use of small lights in order to illuminate the license plate on the back of the jacket so the license plate is still easily seen at night and in foggy or rainy weather. Unlike previous designs where lights on clothing are used as an entertainment device, the illumination of the plate does not detract from the plate itself but enhance it and increase visibility of the plate. The lights are centered near the plate and directed towards the plate. They do not detract from the plate but make it more evident.

A similar embodiment would be the use of reflective numbers used for the license plate number, or there may be reflective paint applied directly to the plate. In this fashion the plate would be easily seen in inclement weather and at nighttime. The present invention can be combined with the various alternative embodiments or used without the lights or the hooks.

### BRIEF DESCRIPTION OF THE DRAWINGS

FIG. 1 is a view of the present embodiment as placed upon the motorcycle jacket.

FIG. 2 is a close-up view of the present embodiment.

FIG. 3 is an alternative embodiment of the present invention with hooks.

FIG. 4 is an alternative embodiment of the present invention with lights.

### DETAILED DESCRIPTION OF THE PREFERRED EMBODIMENT

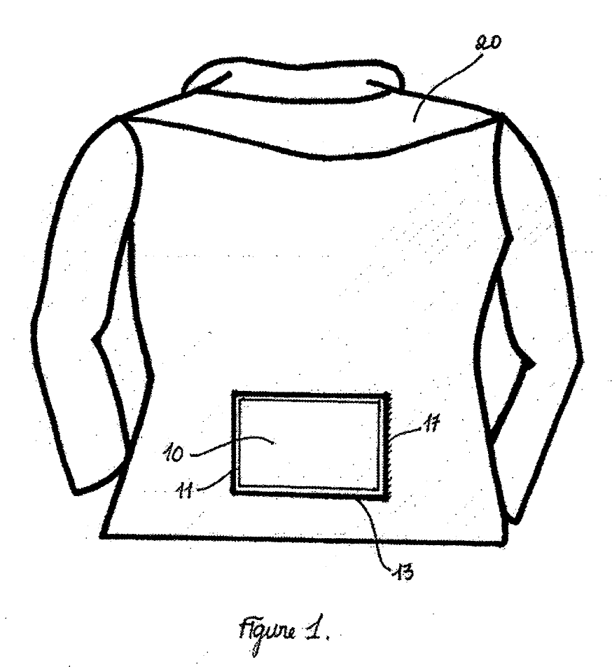

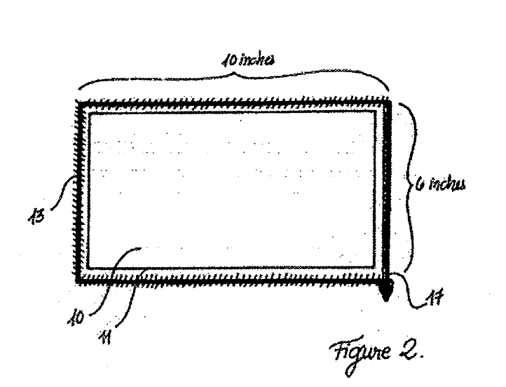

The components of the present invention include: a pouch 10, plate 11, stitching 13, closure 17, hooks 18, lights 19, and jacket 20. As shown in FIG. 1, the pouch 10 measures six inches by ten inches and is made of transparent vinyl. The pouch 10 is mounted in the lower section of the back of the motorcycle jacket 20 with industrial-strength stitching 13. The plate 11 is mounted on the lower section, or “small” of the back, in order to ensure that other drivers can easily see the plate 11. The license plate 11 or other customized plate 11 is inserted into the pouch 10. As shown in FIG. 2, a fastening device 17 (for example, a zipper or hook-and-loop closures) on the right side of the pouch 10 securely encloses the license plate 11 within the pouch 10. In another embodiment of the present invention, the zipper 17 contains a locking mechanism that will prevent loss or theft of the license plate 11 from the pouch 10. The pouch 10 can be situated along the back of the jacket 20 from below the user's shoulder blades so as not to interfere with the user's movement of shoulders. Preferably, the pouch 10 is positioned on jacket 20 near the tailbone of the user. In case of an accident, it is contemplated that the user's tailbone would be protected by the license plate 11 housed in pouch 10, should pouch 10 be positioned near the tailbone of the user.

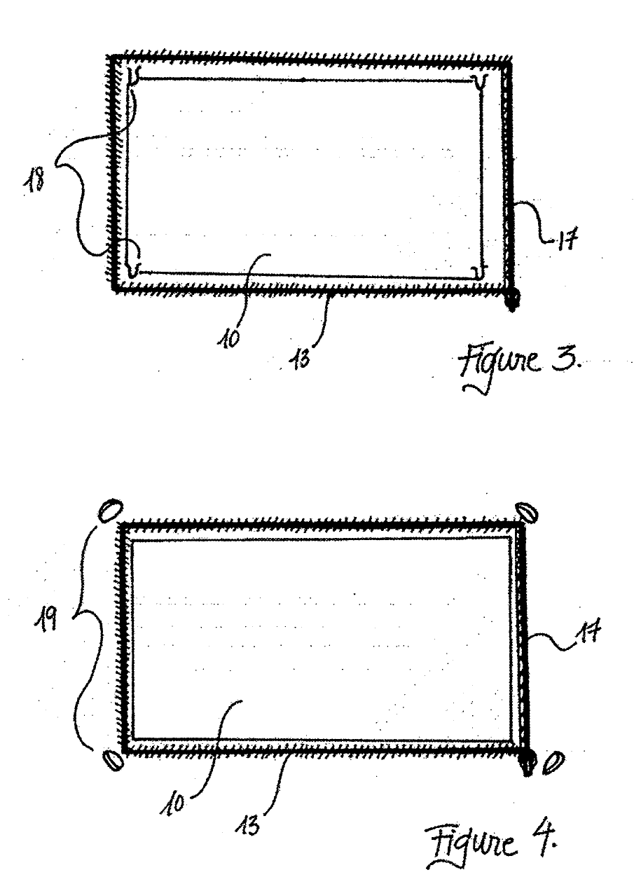

Alternative embodiments of the present invention include hooks 18 on the interior of the pouch 10, which serve as additional support for the license plate 11, as shown in FIG. 3. A second alternative embodiment of the present invention is the addition of lights 19 centered about the pouch 10 in order to increase visibility of said plate 11, as shown in FIG. 4. The lights 19 are preferably LED's, but can be any conventional light source, and lights 19 can be powered in any conventional manner, such as battery-operated. The lights 19 protrude through the garment near the license plate 11 and pouch 10. Reflective paint on the plate 11 would be an additional feature to increase visibility of the plate 11.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

What is claimed is:

1. A motorcycle jacket license display comprising:
a pouch made of a durable, transparent material configured to be mounted on the back of a jacket.

2. The display of claim 1 wherein said pouch is configured to house a license plate.

3. The display of claim 2 wherein said pouch is configured to be mounted on the lower back of a jacket.

4. The display of claim 2 wherein said pouch is configured to be mounted on a jacket below a user's shoulder blades.

5. The display of claim 2 wherein said pouch is configured to be mounted on a jacket near a user's tailbone.

6. The display of claim 2 further comprising a fastening mechanism in communication with said pouch.

7. The display of claim 2 wherein said pouch has hooks to provide additional support to the plate.

8. The display of claim 2 further comprising lights in communication with said pouch.

9. The display of claim 1 wherein said pouch is made of plastic.
